(19) United States
(12) Patent Application Publication
(10) Pub. No.: US 2011/0280986 A1
(43) Pub. Date: Nov. 17, 2011

(54) MOLD STRUCTURE FOR INJECTION MOLDING

(76) Inventors: Xian Yun Wang, Taipei (TW); Xiaoping Wu, Taipei (TW); Shih-Hsiung Ho, Taipei (TW)

(21) Appl. No.: 12/781,804

(22) Filed: May 17, 2010

(51) Int. Cl. B29C 45/36

(52) U.S. Cl. 425/577

(57) ABSTRACT

A mold structure for injection molding includes a main body and a plurality of inserts. The main body defines a top surface. The top surface has a rectangular molding chamber. A bottom of the molding chamber is formed with a plurality of abreast fixing grooves extending upwards and downwards. Each of the fixing grooves has a side formed with a slot extending upwards and downwards. The slot further extends upwards to reach the top surface. Each of the inserts has a base of strip shape, and a fixing portion of strip shape protruded outwards from a portion of a side surface of the base. The base is fixed in the fixing groove, with an upper portion thereof exposed in the molding chamber. The fixing portion is engaged in the slot for restraining the upper portion of the base from deflection in molding process.

### BACKGROUND OF THE INVENTION

1. Field of the Invention

The present invention relates to a mold structure, and particularly to a mold structure for injection molding.

2. The Related Art

More and more electronic devices are designed and used in daily life, especially portable electronic devices. The portable electronic devices, which have multiple functions, miniature configuration and high quality, are more and more popular with consumers. At present, most components of the portable electronic devices are manufactured by the injection molding for increasing the production efficiency and reducing the manufacture cost, especially the miniature components. However, since the mold structure, for molding the miniature components, has a small and weak strength, it is apt to deform or even damage when the thermoplastic resin being injected into the mold. Therefore, it is desirable to design a mold structure to solve the problem mentioned above.

### SUMMARY OF THE INVENTION

Accordingly, an object of the present invention is to provide a mold structure. The mold structure for injection molding includes a main body defining a top surface, and a plurality of inserts. The top surface has a rectangular molding chamber. A bottom of the molding chamber is formed with a plurality of abreast fixing grooves extending upwards and downwards. Each of the fixing grooves has a side formed with a slot extending upwards and downwards. The slot further extends upwards to reach the top surface. Each of the inserts has a base of strip shape, and a fixing portion of strip shape protruded outwards from a portion of a side surface of the base. The base is fixed in the fixing groove, with an upper portion thereof exposed in the molding chamber. The fixing portion is buckled in the slot for restraining the upper portion of the base from deflection in molding process.

As described above, the inserts are mounted to the main body. The upper portions of the bases are exposed in the molding chamber, which is capable of forming pin holes of an insulating housing of an electronic device (not shown). The insert has the fixing portion engaged in the slot, which is effective to restrain the upper portion from deflection in molding process, thereby guaranteeing the excellent quality of the pin holes.

### BRIEF DESCRIPTION OF THE DRAWINGS

The present invention will be apparent to those skilled in the art by reading the following description thereof, with reference to the attached drawings, in which:

FIG. 1 is an exploded, perspective view of a mold structure of an embodiment in accordance with the present invention;

FIG. 2 is an assembled, perspective view of the mold structure shown in FIG. 1; and

FIG. 3 is a cross-sectional view of the mold structure shown in FIG. 2.

### DETAILED DESCRIPTION OF THE EMBODIMENT

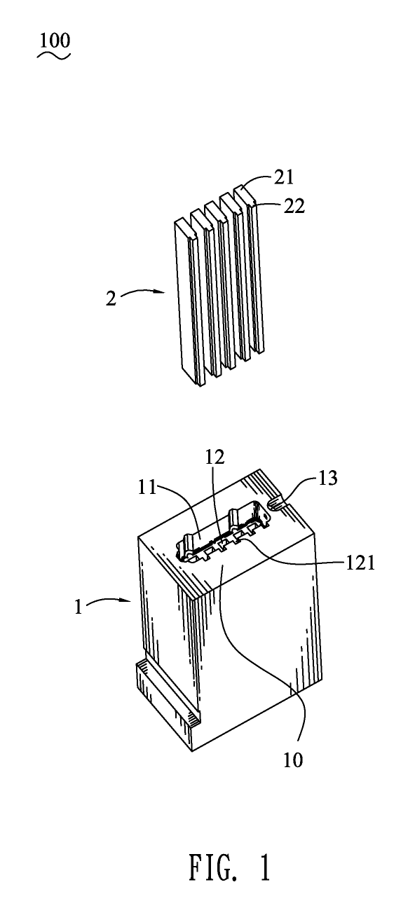

Referring to the drawings in greater detail, and refer to FIGS. 1-2, the embodiment of the invention is shown in a mold structure 100. The mold structure 100, with a mating molding structure (not shown) coupled therewith for injection molding, comprises a main body 1, and a plurality of inserts 2 mounted in the main body 1.

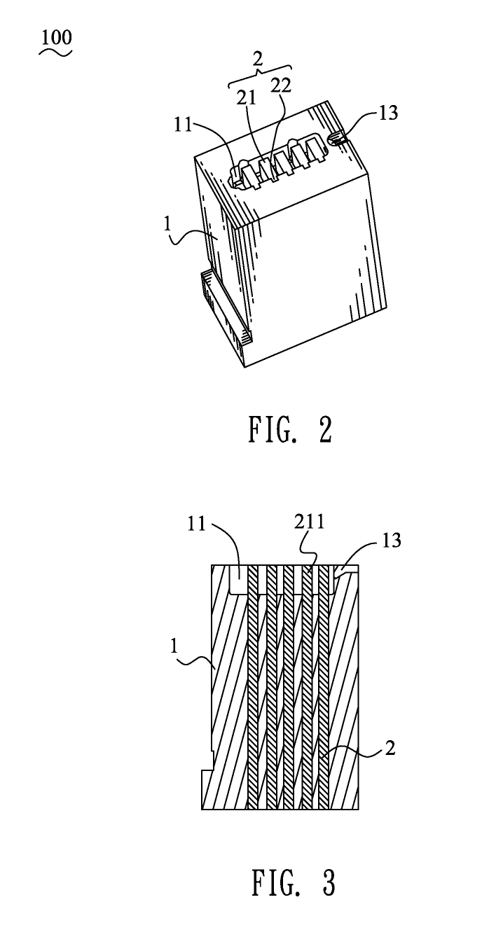

With reference to FIGS. 1-3, the main body 1 is a substantially rectangular block shape, and defines a top surface 10, as a mating surface. The top surface 10 has a molding chamber 11 at a middle portion thereof. The molding chamber 11 is substantially rectangular. A bottom of the molding chamber 11 is formed with a plurality of abreast fixing grooves 12. The fixing grooves 12 extend upwards and downwards, and pass through the whole main body 1. A slot 121 is formed at a middle portion of an end of each fixing groove 12 and extends upwards to penetrate the top surface 10. In this embodiment, the slot extends upwards and downwards, and passes through the whole main body. The top surface 10 further has a sprue channel 13 at an end thereof. The sprue channel 13 extends along a lengthways direction of the molding chamber 11 and penetrates into the molding chamber 11.

The insert 2 has a base 21 of strip shape, and a fixing portion 22 of strip shape protruded outwards from a middle portion of a side surface of the base 21. The base 21 is installed and fixed in the fixing groove 12, with an upper portion 211 exposed in the molding chamber 11. The fixing portion 22 is engaged with the slot 121. In this embodiment, a top surface of each insert 2 is substantially flush with the top surface 10 of the main body 1. In the process of injection molding, the mold structure 100 is coupled with the mating molding structure. The thermoplastic resin (not shown) is injected into the molding chamber 11 through the sprue channel 13. As the fixing portions 22 are engaged with the slots 121, the upper portions 211 of the base 21, which are exposed in the molding chamber 11, are restrained and keep in position in the molding process, which prevents the upper portions 211 from deflecting and deforming under the action of the flushing force from the thermoplastic resin, consequently, guaranteeing the excellent quality of the molded product.

As described above, the inserts 2 are mounted to the main body 1. The upper portions 211 of the bases 21 are exposed in the molding chamber 11, which is capable of forming pin holes of an insulating housing of an electronic device (not shown). The insert 2 has the fixing portion 22 engaged in the slot 121, which is effective to restrain the upper portion 211 from deflection in molding process, thereby guaranteeing the excellent quality of the pin holes.

What is claimed is:

1. A mold structure for injection molding, comprising:
a main body defining a top surface, the top surface having a rectangular molding chamber, a bottom of the molding chamber being formed with a plurality of abreast fixing grooves extending upwards and downwards, each of the fixing grooves having a side formed with a slot extending upwards and downwards, the slot further extending upwards to reach the top surface; and
a plurality of inserts, each of the inserts having a base of strip shape, and a fixing portion of strip shape protruded outwards from a portion of a side surface of the base,
wherein the base is fixed in the fixing groove, with an upper portion thereof exposed in the molding chamber, the fixing portion is engaged in the slot for restraining the upper portion of the base from deflection in molding process.

2. The mold structure as claimed in claim 1, wherein a top surface of the insert is substantially flush with the top surface of the main body.
